(19) United States
(12) Patent Application Publication
(10) Pub. No.: US 2025/0061166 A1
(43) Pub. Date: Feb. 20, 2025

(54) NATIVE ADVERTISEMENT OVERLAYS

(71) Applicant: Nativo, Inc., El Segundo, CA (US)

(72) Inventors: Marcelo Muniz, Playa Vista, CA (US); Joshua Steven Fledderjohn, Los Angeles, CA (US)

(21) Appl. No.: 18/235,242

(22) Filed: Aug. 17, 2023

(51) Int. Cl. G06F 16/958; G06Q 30/0241

(52) U.S. Cl. CPC G06F 16/986; G06Q 30/0277

(57) ABSTRACT

A request for a native advertisement to be included in an instance of a publisher content page is received. In response to the request code comprising the native advertisement is sent to a requesting client via a communication interface. When executed by the requested client, the code causes the requesting client to modify the instance of the publisher content page to include an element to display a native advertisement content as an overlay covering at least a portion of the modified instance of the publisher content page responsive to a user input associated with the element included in the modified instance of the publisher content page and display the modified instance of the publisher content page.

### BACKGROUND OF THE INVENTION

“Native” advertising refers to techniques to serve ads in a manner that integrates more naturally into the style, layout, and appearance of a page in which the advertisement is displayed. For example, an ad may be displayed in a reserved location within a “newsfeed” style display, in which each of a plurality of articles is represented by a summary, possibly including a representative image, and advertisements may be displayed in the reserved location as “sponsored” or “promoted” content, with the ad comprising a summary of a sponsored article and being formatted so as to fit the look and feel of the rest of the publisher's page. Instead of appearing off to the side or across the top of a web page, native ads mimic the look, feel, and function of the page's content. In the approach typically used by advertising providers, however, selection of the ad or other sponsored content by the user results in a link out to a third party web site being activated, with the consequence that the user's attention is pulled away from the publisher's page and site and directed instead to the third party site.

### BRIEF DESCRIPTION OF THE DRAWINGS

Various embodiments of the invention are disclosed in the following detailed description and the accompanying drawings.

FIG. 1 is a block diagram illustrating an embodiment of a content page that includes a native advertisement that embodies a link to external content.

FIG. 2 is a block diagram illustrating an instance of a publisher content page in accordance with some embodiments.

FIG. 3A is a block diagram illustrating the content associated with a native advertisement being displayed in accordance with some embodiments.

FIG. 3B is a block diagram illustrating the content associated with a native advertisement being displayed in accordance with some embodiments.

FIG. 4A is a block diagram illustrating an embodiment of a system to provide an instance of a publisher content page.

FIG. 4B is a block diagram illustrating an embodiment of a system to provide a native advertisement.

FIG. 5A is a flow diagram illustrating a process of providing a modified instance of a publisher content page in accordance with some embodiments.

FIG. 5B is a flow diagram illustrating a process of providing a native advertisement in accordance with some embodiments.

FIG. 5C is a flow diagram illustrating a process of determining which version of a native advertisement content to provide for an instance of a publisher content page in accordance with some embodiments.

FIG. 6 is a flow diagram illustrating a process of displaying a modified instance of a publisher content page in accordance with some embodiments.

FIG. 7 is a diagram illustrating an example of a modified instance of a publisher content page in accordance with some embodiments.

FIG. 8 is a diagram illustrating an example of a native advertisement content being displayed as an overlay in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques to provide native advertising content are disclosed. A client system, such as a browser or application, receives a request for a publisher content page (e.g., content landing page). In some embodiments, the client system retrieves the publisher content page from a publisher content server. The retrieval results in an ad call being sent to a publisher ad server. The publisher ad server retrieves the advertisement from an ad content server.

The ad content server may determine which portion of the publisher content page corresponds to a header of the publisher content page. In some embodiments, the ad content server uses a template specific to a publisher of the publisher content page to determine which portion of the publisher content page corresponds to the header. The template may include a CSS selector that indicates which portion of the HTML code of the publisher content page corresponds to the header of the publisher content page. In some embodiments, a template for the publisher content page does not exist and the ad content server analyzes the code associated with the publisher content page to determine which portion of the publisher content page corresponds to the header of the publisher content page.

The ad content server provides the advertisement as executable code (e.g., a script) to the publisher ad server. The executable code may include metadata to render a native advertisement, metadata to render the content associated with the native advertisement (e.g., overlay execution metadata), and the content associated with the native advertisement (e.g., an image, article, or other content promoting a product or service). The publisher ad server provides the executable code to the client system.

The native advertisement content (e.g., an article, a video, an image, etc.) is provided with the native advertisement even though the user may not select the native advertisement content for display. This enables the native advertisement content to be loaded faster in the event the user selects the native advertisement than if a separate call was made for the native advertisement content responsive to a user selection. That is, the native advertisement content is prefetched, however, the content associated with the native advertisement is not visible to the user unless the client browser or application receives a selection of the native advertisement.

The client system completes the request for the publisher content page by providing the native advertisement. The publisher content page includes a header, the content of the publisher content page (e.g., one or more article previews), and one or more native advertisements. In some embodiments, the client system receives a selection of a native advertisement. In response to the selection, the client system executes the executable code, which causes the client system to display the native advertisement content using the metadata to render the content associated with the native advertisement and the native advertisement content that was included in the executable code. The client system may render the content associated with the native advertisement as an overlay under the header associated with the publisher content page. The metadata to render the content associated with the native advertisement may cause the client system to render the content of the native advertisement as an overlay that covers some or all of the area below the header of the publisher content page. The content of the native advertisement may be displayed over the area of the publisher content page reserved for content. In some embodiments, the metadata to render the content associated with the native advertisement causes the script to render the content of the native advertisement as an overlay that entirely covers the publisher content page. As a result, the user's attention is not pulled away from the publisher's page even though they are viewing native advertisement content. That is, the user may believe they are viewing content associated with the publisher's page because the native advertisement content is displayed below the publisher's header, logo, or other identifying information.

In other embodiments, the client system sends a request for the publisher content page that is resolved (e.g., through DNS routing) to a content distribution network (CDN) edge server. The CDN edge server is configured to obtain content for an instance of the publisher content page from the publisher's content management system.

The CDN edge server may determine which portion of the publisher content page corresponds to a header of the publisher content page. In some embodiments, the CDN edge server uses a template specific to a publisher of the publisher content page to determine which portion of the publisher content page corresponds to the header. The template may include a CSS selector that indicates which portion of the HTML code of the publisher content page corresponds to the header of the publisher content page. In some embodiments, a template for the publisher content page does not exist and the CDN server analyzes the code associated with the publisher content page to determine which portion of the publisher content page corresponds to the header of the publisher content page.

The CDN edge server may modify the code associated with the publisher content page to include executable code (e.g., a script) that includes metadata to render a native advertisement, metadata to render the content associated with the native advertisement (e.g., overlay execution metadata), and the content associated with the native advertisement (e.g., an image, article, or other content promoting a product or service). The CDN edge server provides the modified instance of the publisher content page to the client system. The CDN edge server may modify the code associated with the instance of the publisher content page for one or more native advertisements that are to be displayed in the publisher content page.

The content associated with the native advertisement is provided with the instance of the publisher content page even though the user may not select the native advertisement content for display. This enables the content associated with the native advertisement to be loaded faster in the event the user selects the native advertisement than if a separate call was made for the content associated with the native advertisement responsive to a user selection. That is, the content associated with the native advertisement is preloaded with the instance of the publisher content page, however, the content associated with the native advertisement is not visible to the user unless the client system receives a selection of the native advertisement.

The client system completes the request for the publisher content page by providing the instance of the publisher content page. The instance of the publisher content page includes a header, the content of the publisher content page (e.g., one or more article previews), and one or more native advertisements. The instance of the publisher content page may include a footer at the bottom of the instance of the publisher content page.

In some embodiments, the client browser or application receives a selection of a native advertisement. The client system may be running a script (e.g., JavaScript). In response to the selection, the script renders the content associated with the native advertisement using the metadata to render the content associated with the native advertisement that was included in the modified instance of the publisher content page and the content associated with the native advertisement. The client system may render the content associated with the native advertisement as an overlay under the header associated with the modified instance of the publisher content page. The metadata to render the content associated with the native advertisement may cause the script to render the content of the native advertisement as an overlay that covers some or all of the area below the header of the publisher content page. The content of the native advertisement may be displayed over the area of the publisher content page reserved for content. In some embodiments, the metadata to render the content associated with the native advertisement causes the script to render the content of the native advertisement as an overlay that covers the publisher content page. As a result, the user's attention is not pulled away from the publisher's page even though they are viewing native advertisement content. That is, the user may believe they are viewing content associated with the publisher's page because the native advertisement content is displayed below the publisher's header, logo, or other identifying information.

The client system may include a script to monitor a behavior associated with the user viewing the native advertisement content. The monitored behavior associated with the user may include a scrolling behavior (e.g., an amount of time the user is scrolling on a page, a location of the cursor on the page), a selection behavior (e.g., which content the user selects or does not select), etc. User engagement metrics may be determined based on the monitored behavior.

The client system may receive a selection to close the native advertisement content. In response to the selection, the client system removes the native advertisement overlay from a rendering of the instance of the publisher content page and returns to rendering the content of the publisher content page (e.g., one or more article previews) and the one or more native advertisements.

The client system may receive a selection to close the publisher content page. In response to the selection, the client system removes from the code associated with the instance of the publisher content page the metadata to render a native advertisement, the metadata to render the content associated with the native advertisement, and the content associated with the native advertisement.

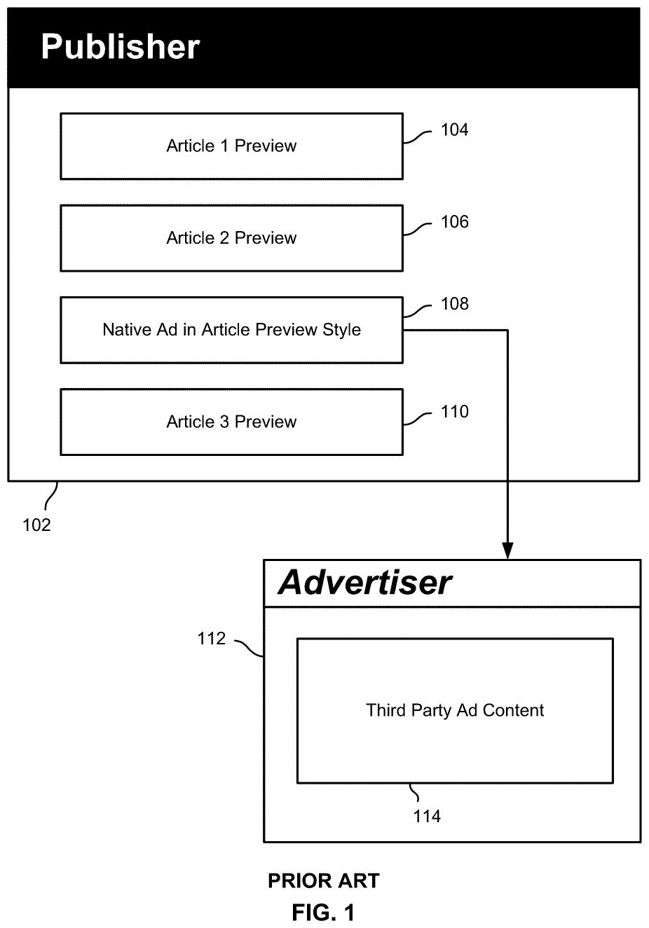

FIG. 1 is a block diagram illustrating an embodiment of a content page that includes a native advertisement that embodies a link to external content. In the example shown, a publisher content page 102, e.g., as rendered a given client system/device includes four display locations (104, 106, 108, and 110) in a newsfeed interface. In the example shown, the first, second, and fourth locations (104, 106, 110) are used to display previews of non-advertising content of the publisher. The third location in the newsfeed is used to display a native ad 108. The native ad 108 may have the same format, structure, and appearance as article previews 104, 106, and 110, but may be associated with advertising content. For example, advertising content to promote a product may be represented in native ad 108 as a preview of an article about the product. In some embodiments, an indication may be displayed to provide notice to users that a given preview is associated with advertising content.

In the example shown in FIG. 1, selection of the native ad 108 results in the browser software that had been used to display publisher content page 102 navigating away from page 102 to a new page 112 provided by the advertiser (in this example) or another third party. The page includes advertising content 114, e.g., an image, article, or other content promoting a product or service.

Linking native ads to third party sites, as in the example shown in FIG. 1, may cause one or more issues. First, users may expect that a click on anything that looks like an article (e.g., the native ad 108 in example shown in FIG. 1) will link them to an article on the same web site they are currently on. If when they click a native ad link they are taken to a third party advertiser site, it's an unexpected result and this often negatively impacts the user's willingness to engage with the advertising content, such as by reading, viewing, or otherwise interacting with the content. They will often “bounce” or leave the third party site without engaging with the content or anything on the site. The second problem is that there is no way for the publisher or other site owner that sold the native ad to track and report user engagement metrics once the user leaves their site. The only way to do so would be to ask the advertiser to place a JavaScript or other method of tracking on their site—this can often be a hassle for the advertiser so they usually only do this with select publishers that they work with.

In the approach disclosed herein, when a native ad links to a third party site, in various embodiments, selection of the native ad by a user results in content from the third party being display as an overlay on top of the publisher content page. In various embodiments, the approach disclosed herein makes it feel less like the user is leaving the publisher's site and also enables the publisher (or other originating site owner) to retain tracking capabilities.

In various embodiments, tracking capabilities provided via an overlay may include one or more of the following: time viewing the third party content as displayed in the overlay; scroll behavior; mouse position; clicks/touches on links or controls; and user interaction with interactive elements on the page.

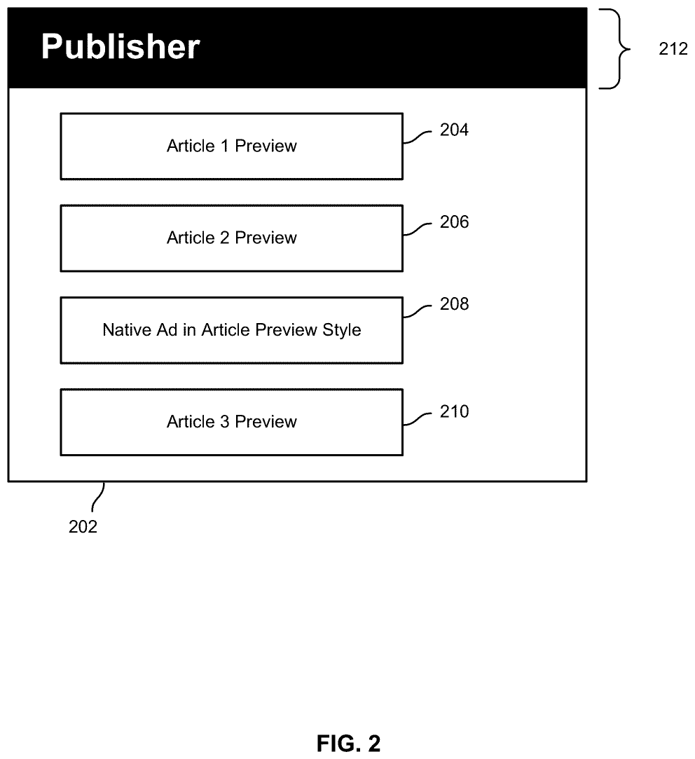

FIG. 2 is a block diagram illustrating an instance of a publisher content page in accordance with some embodiments. In the example shown, the publisher content page 202, as rendered on a client device, includes a header 212, a first display location 204 for a first publisher content, a second display location 206 for second publisher content, a third display location 208 for a native advertisement, and a fourth display location 210 for third publisher content.

The first publisher content, the second publisher content, and the third publisher content may be an article preview. The native advertisement may have the same format, structure, and appearance as the first, second, and third publisher content.

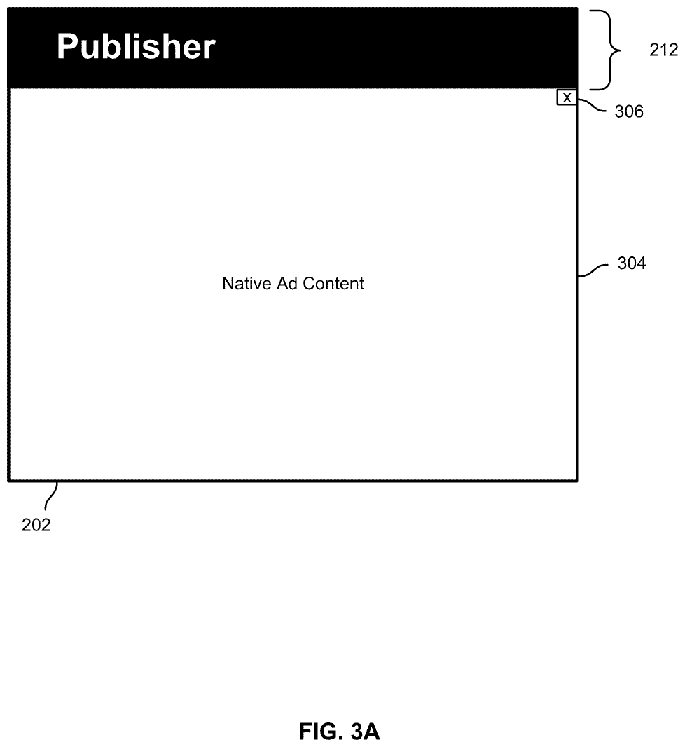

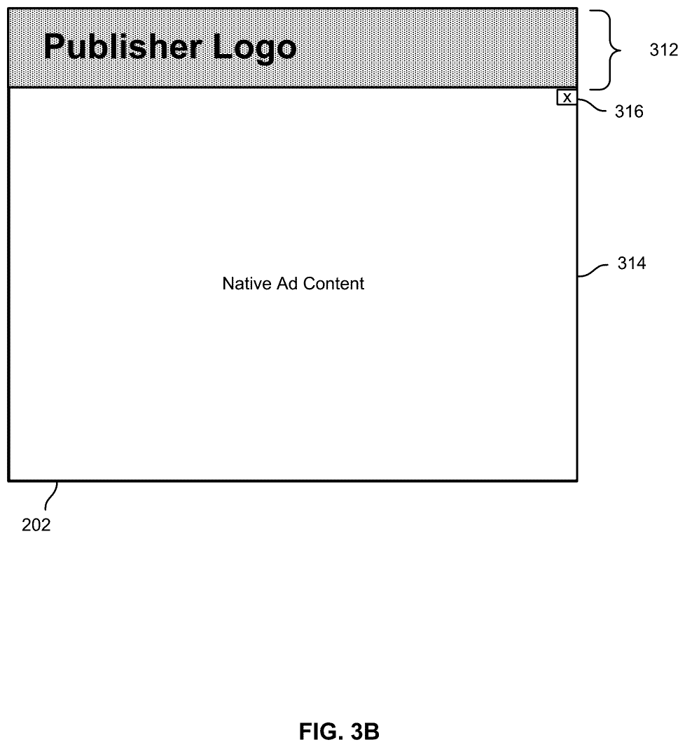

The client device may receive a selection of the native advertisement displayed at the third display location 208. In response to the selection, as seen in FIG. 3A, content associated with the native advertisement is displayed as an overlay 304 that covers the first display location 204, the second display location 206, the third display location 208, and the fourth display location 210. The overlay 304 includes a close button 306. The overlay 304 is displayed below header 212. In some embodiments, the overlay 304 covers some or all of the area below header 212 of the modified instance of publisher content page 202. In some embodiments, the publisher content page 202 includes a footer (not shown) and the overlay 304 covers an entire main content area of the publisher content page 202 (i.e., the area between the header and the footer).

In some embodiments, in response to the selection, as seen in FIG. 3B, content associated with the native advertisement content is displayed as an overlay 314 that covers the first display location 204, the second display location 206, the third display location 208, and the fourth display location 210. Overlay 314 includes a close button 316. Overlay 314 is a full page overlay and displayed over header 212. Overlay 314 includes a header 312. Header 312 may include a logo associated with a publisher content page, a publication name associated with the publisher, or other identifying elements associated with a publisher of the publisher content page.

The client system may receive a selection of close button 306 or close button 316, the publisher content page 202 returns to being rendered in a manner as seen in FIG. 2.

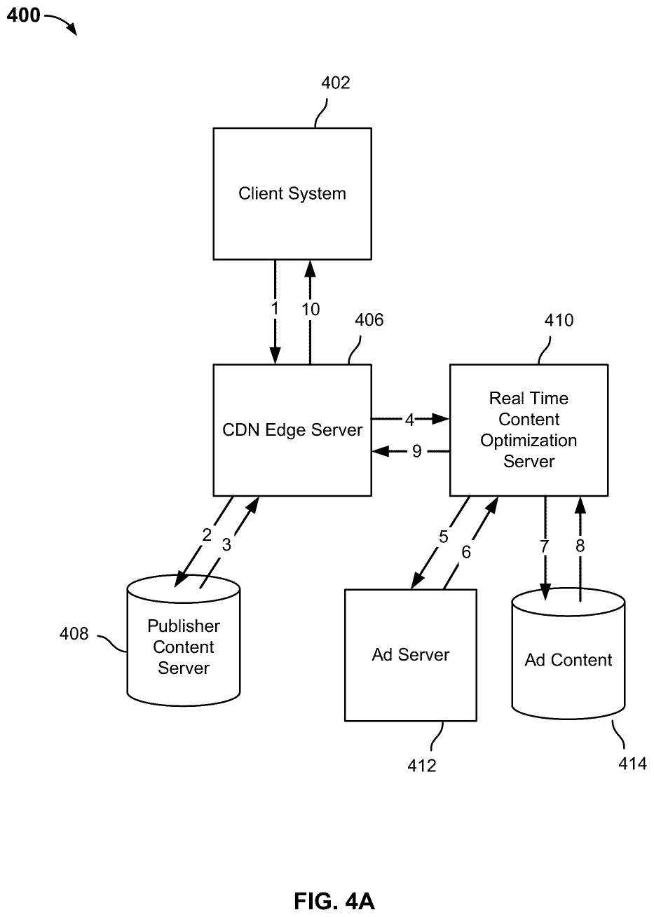

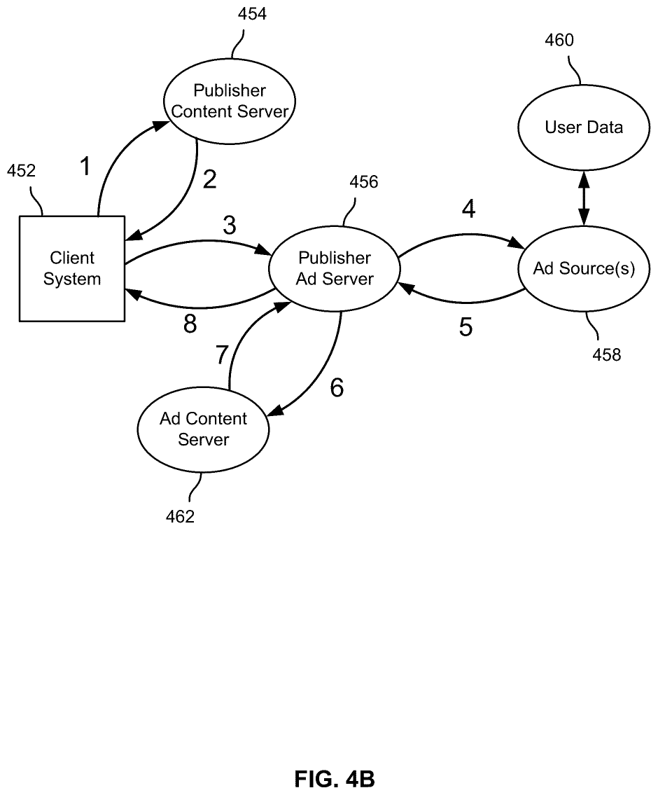

FIG. 4A is a block diagram illustrating an embodiment of a system to provide an instance of a publisher content page. In the example shown, system 400 includes a client/browser 402 that requests (arrow “1”) a publisher content page. The request is resolved (e.g., through DNS routing, such as CNAME) to a CDN edge server 406. CDN edge server 406 is configured to obtain publisher content for the page from the publisher's content server 408, e.g., the publisher's content management system (CMS) (arrows “2” and “3”). In various embodiments, the CDN edge server 406 may be configured to cache the publisher content page, e.g., for a prescribed time.

The CDN edge server 406 provides the publisher content page (arrow “4”) to a real time content optimization service 410, along with the original page uniform resource locator (URL) (i.e., the request by the user associated with client/browser 402) and information about the requesting user (e.g., from a cookie on the client/browser 402). In some alternative embodiments, the real time content optimization server 410 obtains the publisher content page directly from the publisher content server 408. In various embodiments, real time content optimization server 410 parses the publisher content page to determine its structure and to extract component publisher content elements (e.g., articles, images, video, etc.) and advertising-related and other scripts. In some embodiments, scripts are parsed to determine meta-information required to identify and obtain ad content, e.g., ad content targeted for the user based on the user information received by the real time content optimization server 410 from the CDN edge server 406. In some embodiments, observed and/or user-configured preferences of the user may be used by the real time content optimization server 410 to identify/select ads for the user.

In various embodiments, real time content optimization server 410 interacts (arrows “5” and “6”) with a third-party ad server 412 to identify one or more ads to be included in the page, and obtains ad content (arrows “7” and “8”) from a source of ad content 414. In some alternative embodiments, only ad HTML is injected to the page, and when the browser 402 renders the page (with the ads), the browser 402 fetches the relevant multiple-media files, such as images, from the source of ad content 414. The real time content optimization server 410 in various embodiments injects/includes the obtained ad content in the ad locations (slots) it selects, e.g., based on publisher rules and/or criteria in some embodiments, to be included in the page.

In some embodiments, real time content optimization server 410 optimizes publisher content as included in the page. For example, real time content optimization server 410 may adapt the editorial (publisher) content to better fit the user's preference. This may include, but is not limited to, promoting articles the user is likely to read, demoting articles already read by this specific user etc.

In various embodiments, consumption of publisher content elements, by an individual user and/or across users, is tracked and used to optimize the selection and/or placement of content. In some embodiments, content consumption is tracked as disclosed in U.S. Pat. No. 9,912,768, entitled MEASURING CONTENT CONSUMPTION, issued Mar. 6, 2018, the entire contents of which are incorporated herein by reference for all purposes.

In various embodiments, real time content optimization server 410 composes and returns to the CDN edge server 406 (arrow “9”) a flattened (e.g., ad-related JavaScript and/or other scripts omitted) and optimized (e.g., publisher content elements ads selected and/or placement optimally for the requesting user) page.

The CDN edge server 406 determines which portion of the publisher content page corresponds to a header of the publisher content page. In some embodiments, the CDN edge server 406 uses a template specific to a publisher of the publisher content page to determine which portion of the publisher content page corresponds to the header. The template may include a CSS selector that indicates which portion of the HTML code of the publisher content page corresponds to the header of the publisher content page. In some embodiments, a template for the publisher content page does not exist and the CDN edge server 406 analyzes the code associated with the publisher content page to determine which portion of the publisher content page corresponds to the header of the publisher content page.

The CDN edge server 406 modifies the code associated with the publisher content page to include metadata to render a native advertisement, metadata to render the content associated with the native advertisement (e.g., overlay execution metadata), and the content associated with the native advertisement (e.g., e.g., an image, article, or other content promoting a product or service). The CDN edge server 406 may modify the code associated with the publisher content page for one or more native advertisements that are to be displayed by the publisher content page.

The content associated with the native advertisement is provided with the modified instance of the publisher content page even though the user may not select the native advertisement. This enables the content associated with the native advertisement to be loaded faster in the event the user selects the native advertisement than if a separate call was made for the content associated with the native advertisement responsive to a user selection. That is, the content associated with the native advertisement is preloaded with the modified instance of the publisher content page, however, the content associated with the native advertisement is not visible to the user unless the client browser or application receives a selection of the native advertisement.

The CDN edge server 406 serves the modified instance of the publisher content page (arrow “10”) to the client/browser 402, which is able to render the page relatively quickly, since at least some of the ad-related scripts are not included and the required publisher and ad content are included in the page as served. In addition, techniques disclosed herein result in a page being served in which the page HTML is not being changed while the browser needs to render it, since the ads have already been injected, so within a single run, the entire page and ads are rendered.

In some embodiments, ads or other content compatible with the layout of a publisher's page(s) may be determined programmatically. For example, the structure/layout of the publisher's page(s) may be learned and a representation of the structure stored. In some embodiments, layout changes may be detected automatically. For example, the publisher's pages may be crawled periodically and/or on an ongoing basis, and new and/or newly-structured pages may be detected and their structure learned and stored. In some embodiments, techniques are used to quickly extend to other publisher content pages page structure information gleaned previously from other pages having a same/similar structure, e.g., other pages of that same publisher. In some embodiments, page structure may be learned as disclosed in U.S. Pat. No. 9,880,994, entitled DETECTING COMPATIBLE LAYOUTS FOR CONTENT-BASED NATIVE ADS, issued Jan. 30, 2018, the entire contents of which are incorporated herein by reference for all purposes.

FIG. 4B is a block diagram illustrating an embodiment of a system to provide a native advertisement. In the example shown, a client system 452, such as a client browser or application, receives a request for a publisher content page (e.g., content landing page). The client system 452 sends a request (arrow “1”) for a publisher content page from a publisher content server 454. Publisher content server 454 provides the publisher content page (arrow “2”) to the client system 452. The retrieval results in an ad call being sent (arrow “3”) to a publisher ad server 456.

Publisher ad server 456 queries one or more ad sources 458 (arrow “4”), potentially using user data (or other targeting data) 460 to determine an ad to be displayed in the context of the publisher content page. In some embodiments, the ad to be displayed is associated with a winning bid. In some embodiments, header bidding is used to determine the winning bid. In some embodiments, a transparent ad marketplace is used to determine the winning bid. In some embodiments, an auction may be performed in response to the ad call. The publisher ad server 456 obtains (arrows “6” and “7”) the ad from an ad content server 462, rather than passing back to the client system 452 a link or other identifier associated with the ad.

The ad content server 462 determines which portion of the publisher content page corresponds to a header of the publisher content page. In some embodiments, the ad content server uses a template specific to a publisher of the publisher content page to determine which portion of the publisher content page corresponds to the header. The template may include a CSS selector that indicates which portion of the HTML code of the publisher content page corresponds to the header of the publisher content page. In some embodiments, a template for the publisher content page does not exist and the ad content server 462 analyzes the code associated with the publisher content page to determine which portion of the publisher content page corresponds to the header of the publisher content page.

The ad content server 462 provides the ad as executable code (e.g., a script) to the publisher ad server 456. The executable code may include metadata to render a native advertisement, metadata to render the content associated with the native advertisement (e.g., overlay execution metadata), and the content associated with the native advertisement (e.g., an image, article, or other content promoting a product or service). The publisher ad server 456 provides the executable code (arrow “8”) to the client system 452.

The native advertisement content (e.g., an article, a video, an image, etc.) is provided with the native advertisement even though the user may not select the native advertisement content for display. This enables the native advertisement content to be loaded faster in the event the user selects the native advertisement than if a separate call was made for the native advertisement content responsive to a user selection. That is, the native advertisement content is prefetched, however, the content associated with the native advertisement is not visible to the user unless the client system 452 receives a selection of the native advertisement.

The client browser or application completes the request for the publisher content page by providing the native advertisement. The publisher content page includes a header, the content of the publisher content page (e.g., one or more article previews), and one or more native advertisements. In some embodiments, the client browser or application receives a selection of a native advertisement. In response to the selection, the client browser or application executes the executable code, which causes the client browser or application to render the native advertisement content using the metadata to render the content associated with the native advertisement and the native advertisement content that was included in the executable code. The client browser or application may render the content associated with the native advertisement as an overlay under the header associated with the modified instance of the publisher content page. The metadata to render the content associated with the native advertisement causes the client browser or application to render the content of the native advertisement as an overlay that covers some or all of the area below the header of the publisher content page. The content of the native advertisement may be displayed over the area of the publisher content page reserved for content. In some embodiments, the metadata to render the content associated with the native advertisement causes the script to render the content of the native advertisement as an overlay that covers the publisher content page. As a result, the user's attention is not pulled away from the publisher's page even though they are viewing native advertisement content. That is, the user may believe they are viewing content associated with the publisher's page because the native advertisement content is displayed below the publisher's header, logo, or other identifying information.

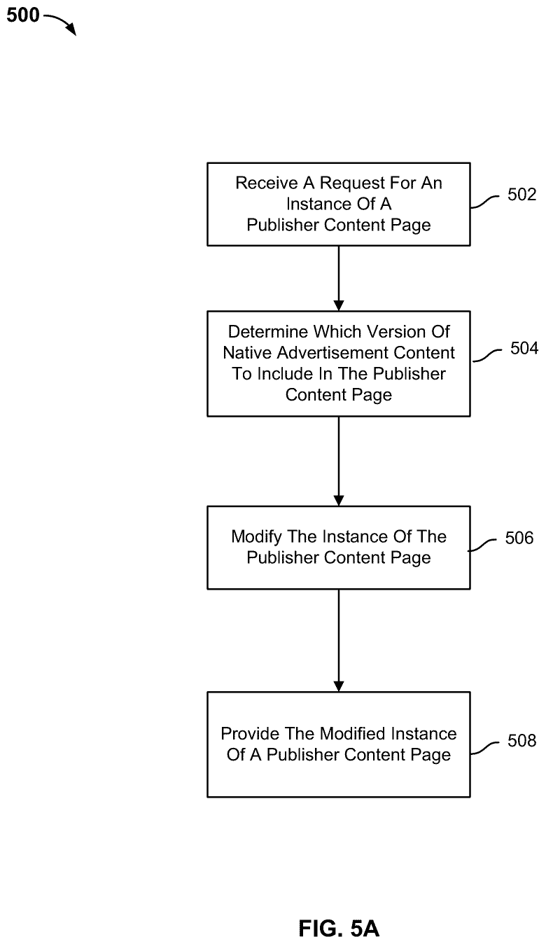

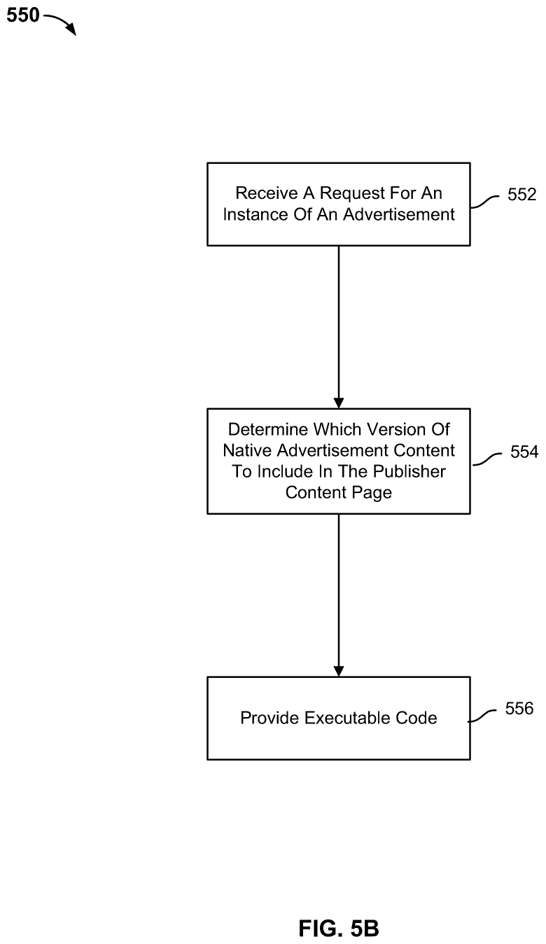

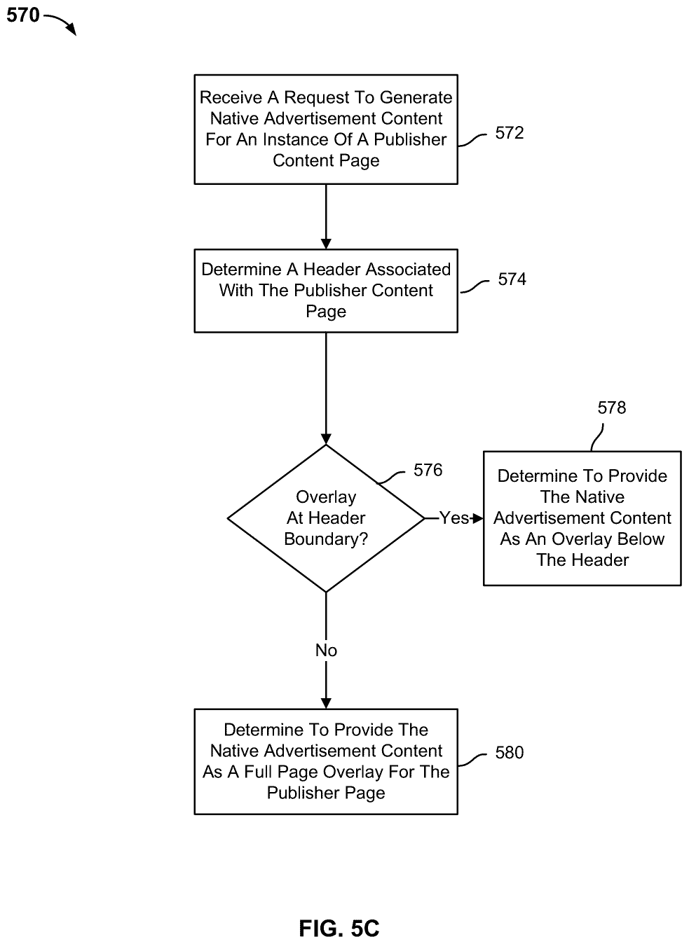

FIG. 5A is a flow diagram illustrating a process of providing a modified instance of publisher content page in accordance with some embodiments. In the example shown, process 500 may be implemented by a server, such as CDN edge server 406.

At 502, a request for an instance of a publisher content page is received. A client system sends a request for the publisher content page that is resolved (e.g., through DNS routing) to a content distribution network (CDN) edge server. The CDN edge server is configured to obtain content for the publisher content page from the publisher's content management system.

At 504, a version of native advertisement content to include in the publisher content page is determined. The CDN edge server determines which portion of the publisher content page corresponds to a header of the publisher content page. In some embodiments, the CDN edge server uses a template specific to a publisher of the publisher content page to determine which portion of the publisher content page corresponds to the header. The template may include a CSS selector that indicates which portion of the HTML code of the publisher content page corresponds to the header of the publisher content page. In some embodiments, the CSS selector is able to determine a boundary associated with the header of the publisher content page. In response to a determination that the boundary associated with the header is able to be determined, the native advertisement content is determined to be included as an overlay that is located directly below the header associated with the publisher content page (e.g., no gap between the header and the overlay). The overlay may cover some or all of the area directly below the header associated with the publisher content page.

In some embodiments, the CSS is unable to determine a boundary associated with the header of the publisher content page. For example, the header may be comprised of multiple elements. As a result, the overlay may be partially obscured when located directly below the header associated with the content page. In response to a determination that the boundary associated with the header is not able to be determined, the native advertisement content is determined to be included as an overlay that covers an entire portion of the publisher content page. The native advertisement content is included in a template comprised of a template header and the native advertisement content. The template header includes a logo associated with a publisher content page, a publication name associated with the publisher, or other identifying elements associated with a publisher of the publisher content page.

In some embodiments, a template for the publisher content page does not exist and the CDN edge server analyzes the code associated with the publisher content page to determine which portion of the publisher content page corresponds to the header of the publisher content page.

In some embodiments, the version of the native advertisement content to include in the publisher content page is based on an identifier associated with the publisher content page (e.g., URL). A publisher content page may be pre-analyzed (e.g., before the request at 502) to determine whether the header associated with the publisher content page is able to be determined and as a result, whether to display the overlay below the header associated with the publisher content page. The CDN edge server may store a data structure that identifies one or more publisher content pages where the native advertisement content is to be included in an overlay that covers an entire portion of the publisher content page. In some embodiments, the CDN edge server utilizes the data structure to determine which version of the native advertisement content to include in the publisher content page.

At 506, the instance of the publisher content page is modified. The instance of the publisher content page is modified to include an element configured to display a native advertisement content as an overlay covering at least a portion comprising the publisher content page responsive to a user input associated with the instance of the publisher content page. The CDN edge server modifies the code associated with the publisher content page (e.g., the document object model (DOM)) to include executable code that includes metadata to render a native advertisement, metadata to render the content associated with the native advertisement (e.g., overlay execution metadata), and the content associated with the native advertisement (e.g., e.g., an image, article, or other content promoting a product or service). The executable code may be Javascript or other type of script. The CDN edge server provides the modified instance of the publisher content page to the client system. The CDN edge server may modify the code associated with the publisher content page for one or more native advertisements that are to be displayed by the publisher content page. In some embodiments, the CDN edge server modifies the publisher content page for a native advertisement associated with a winning auction bid.

The content associated with the native advertisement is provided with the modified instance of the publisher content page even though the user may not select the native advertisement. This enables the content associated with the native advertisement to be loaded faster in the event the user selects the native advertisement than if a separate call was made for the content associated with the native advertisement responsive to a user selection. That is, the content associated with the native advertisement is preloaded with the modified instance of the publisher content page, however, the content associated with the native advertisement is not visible to the user unless the client browser or application receives a selection of the native advertisement.

At 508, the modified instance of the publisher content page is provided. The modified instance of the publisher content page includes a header, the content of the publisher content page (e.g., one or more article previews), and one or more native advertisements. The modified instance of the publisher content page may include a footer.

FIG. 5B is a flow diagram illustrating a process for providing a native advertisement. In the example shown, process 550 may be implemented by an ad content server, such as ad content servers 412, 462.

At 552, a request for an instance of an advertisement is received. A client system receives a request for a publisher content page (e.g., content landing page). The client system retrieves the publisher content page from a publisher content server. The retrieval results in an ad call being sent to a publisher ad server. The publisher ad server sends a request for the instance of the advertisement to an ad content server.

At 554, a version of native advertisement content to include in the publisher content page is determined. The ad content server determines which portion of the publisher content page corresponds to a header of the publisher content page. In some embodiments, the ad content server uses a template specific to a publisher of the publisher content page to determine which portion of the publisher content page corresponds to the header. The template may include a CSS selector that indicates which portion of the HTML code of the publisher content page corresponds to the header of the publisher content page. In some embodiments, the CSS selector is able to determine a boundary associated with the header of the publisher content page. In response to a determination that the boundary associated with the header is able to be determined, the native advertisement content is determined to be included as an overlay that is located directly below the header associated with the publisher content page (e.g., no gap between the header and the overlay). The overlay may cover some or all of the area directly below the header associated with the publisher content page.

In some embodiments, the CSS is unable to determine a boundary associated with the header of the publisher content page. For example, the header may be comprised of multiple elements. As a result, the overlay may be partially obscured when located directly below the header associated with the content page. In response to a determination that the boundary associated with the header is not able to be determined, the native advertisement content is determined to be included as an overlay that covers an entire portion of the publisher content page. The native advertisement content is included in a template comprised of a template header and the native advertisement content. The template header includes a logo associated with a publisher content page, a publication name associated with the publisher, or other identifying elements associated with a publisher of the publisher content page.

In some embodiments, a template for the publisher content page does not exist and the ad content server analyzes the code associated with the publisher content page to determine which portion of the publisher content page corresponds to the header of the publisher content page.

In some embodiments, the version of the native advertisement content to include in the publisher content page is based on an identifier associated with the publisher content page (e.g., URL). A publisher content page may be pre-analyzed (e.g., before the request at 552) to determine whether the header associated with the publisher content page is able to be determined and as a result, whether to display the overlay below the header associated with the publisher content page. The ad content server may store a data structure that identifies one or more publisher content pages where the native advertisement content is to be included in an overlay that covers an entire portion of the publisher content page. In some embodiments, the ad content server utilizes the data structure to determine which version of the native advertisement content to include in the publisher content page.

At 556, executable code is provided. The ad content server provides the advertisement as executable code (e.g., a script) to the publisher ad server. The executable code may include metadata to render a native advertisement, metadata to render the content associated with the native advertisement (e.g., overlay execution metadata), and the content associated with the native advertisement (e.g., an image, article, or other content promoting a product or service).

The client system completes the request for the publisher content page by providing the native advertisement. The publisher content page includes a header, the content of the publisher content page (e.g., one or more article previews), and one or more native advertisements. In some embodiments, the client system receives a selection of a native advertisement. In response to the selection, the client system executes the executable code, which causes the client system to render the native advertisement content using the metadata to render the content associated with the native advertisement and the native advertisement content that was included in the executable code. The client system may render the content associated with the native advertisement as an overlay under the header associated with the modified instance of the publisher content page. The metadata to render the content associated with the native advertisement causes the client browser or application to render the content of the native advertisement as an overlay that covers some or all of the area below the header of the publisher content page. The content of the native advertisement may be displayed over the area of the publisher content page reserved for content. In some embodiments, the metadata to render the content associated with the native advertisement causes the script to render the content of the native advertisement as an overlay that covers the publisher content page. As a result, the user's attention is not pulled away from the publisher's page even though they are viewing native advertisement content. That is, the user may believe they are viewing content associated with the publisher's page because the native advertisement content is displayed below the publisher's header, logo, or other identifying information.

FIG. 5C is a flow diagram illustrating a process of determining which version of a native advertisement content to provide for an instance of a publisher content page in accordance with some embodiments. In the example shown, process 570 may be implemented by a server, such as CDN edge server 406 or ad servers 412, 462. In some embodiments, process 570 is implemented to perform some or all of step 504 of process 500 or step 554 of process 550.

At 572, a request to generate a native advertisement content for an instance of a publisher content page is received. A publisher content page may include one or more locations for a native advertisement. An auction may be performed to determine which native advertisement is allowed to be placed at the one or more locations. A native advertisement associated with a winning bid may be provided in the corresponding location.

At 574, a header associated with the publisher content page is determined. A CSS selector or other type of selector may be used to determine a location of header associated with the publisher content page.

At 576, it is determined whether the native advertisement content is able to be located directly below a boundary of the header associated with the publisher content page. A header may be comprised of one or more elements. In some embodiments, the selector is able to determine a boundary of the header. In some embodiments, the selector is unable to determine a boundary of the header because the header is comprised of multiple elements. As a result, the overlay may be partially obscured when located below the header associated with the content page.

In response to a determination that the native advertisement content is able to be located directly below the boundary of the header associated with the publisher content page, process 570 proceeds to 578. In response to a determination that the native advertisement content is not able to be located directly below the boundary of the header associated with the publisher content page, process 550 proceeds to 580.

At 578, the native advertisement content is determined to be provided as an overlay below the header of the instance of the publisher content page.

At 580, the native advertisement content is determined to be provided as a full page overlay for the instance of the publisher content page.

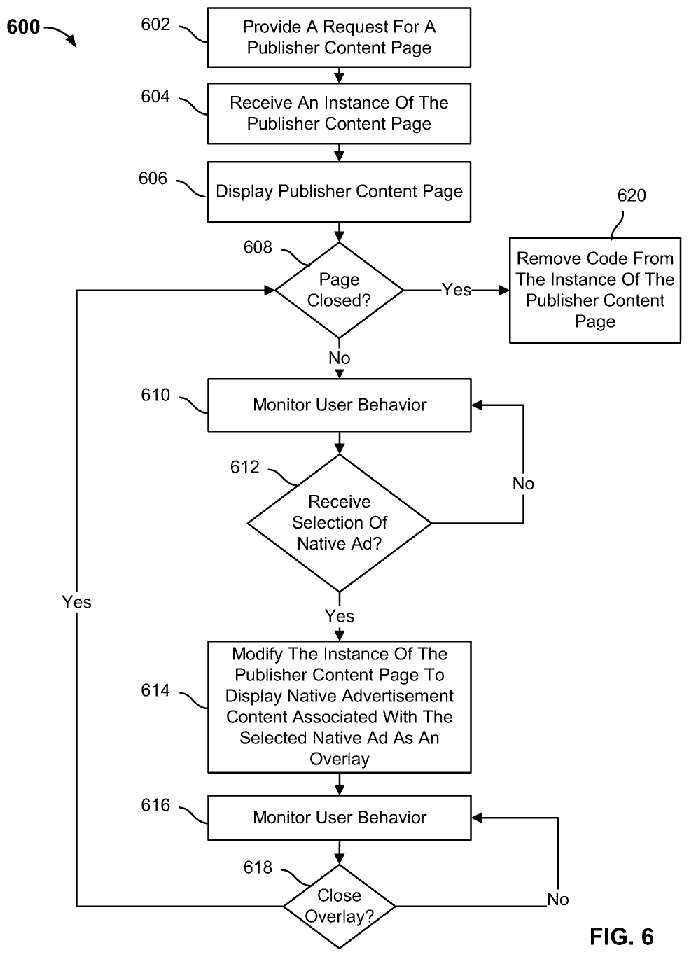

FIG. 6 is a flow diagram illustrating a process of displaying a modified instance of a publisher content page in accordance with some embodiments. In the example shown, process 600 may be implemented by a client system, such as client systems 402, 452.

At 602, a request for a publisher content page is provided. In some embodiments, the request for the publisher content page is resolved (e.g., through DNS routing) to a content distribution network (CDN) edge server. In some embodiment, the request for the publisher content page is resolved to a publisher content server.

At 604, an instance of the publisher content page is received. The instance of the publisher content page includes a header, the content of the publisher content page (e.g., one or more article previews), and one or more native advertisements. A native advertisement may be provided as an executable script (e.g., JavaScript). The instance of the publisher content page may include a footer at the bottom of the publisher content page. In some embodiments, a native advertisement is associated with a winning bid of an auction.

At 606, the publisher content page is displayed.

At 608, it is determined whether a selection to close the instance of the publisher content page is received.

In response to a determination that the selection to close the instance of the publisher content page has been received, process 600 proceeds to 620. In response to a determination that the selection to close the instance of the publisher content page has not been received, process 600 proceeds to 610.

At 610, user behavior is monitored. The monitored behavior associated with the user may include a scrolling behavior (e.g., an amount of time the user is scrolling on a page, a location of the cursor on the page), a selection behavior (e.g., which content the user selects or does not select), etc.

At 612, it is determined whether a selection of a native advertisement is received. In response to a determination that the selection of the native advertisement is received, process 600 proceeds to 614. In response to a determination that the selection of native advertisement is not received, process 600 returns to 610.

At 614, the instance of the publisher content page is modified to display the native advertisement content associated with the selected native advertisement as an overlay. Executable code was provided at step 604 that enables the native advertisement content to be displayed in response to a selection of a native advertisement.

In some embodiments, the content associated with the native advertisement is rendered as an overlay under the header associated with the modified instance of the publisher content page. The metadata to render the content associated with the native advertisement causes the script to render the content of the native advertisement as an overlay that covers some or all of the area below the header of the publisher content page. The content of the native advertisement may be displayed over the area of the publisher content page reserved for content.

In some embodiments, the content associated with the native advertisement is rendered as an overlay that covers an entire portion of the publisher content page. The native advertisement content is included in a template comprised of a template header and the native advertisement content. The template header includes a logo associated with a publisher content page, a publication name associated with the publisher, or other identifying elements associated with a publisher of the publisher content page.

As a result, the user's attention is not pulled away from the publisher's page even though they are viewing a native advertisement. That is, the user may believe they are viewing content associated with the publisher's page because the native advertisement content is displayed below the publisher's header.

At 616, user behavior is monitored. The monitored behavior associated with the user may include a scrolling behavior (e.g., an amount of time the user is scrolling on a page, a location of the cursor on the page), a selection behavior (e.g., which content the user selects or does not select), etc.

At 618, it is determined whether a selection to close the overlay is received. In response to a determination that the selection to close the overlay is not received, process 600 returns to 616. In response to a determination that the selection to receive the close overlay is received, process 600 returns to 608.

At 620, the code is removed from the instance of the publisher content page. The code includes metadata to render a native advertisement, the metadata to render the content associated with the native advertisement, and the content associated with the native advertisement is removed from the modified instance of the publisher content page.

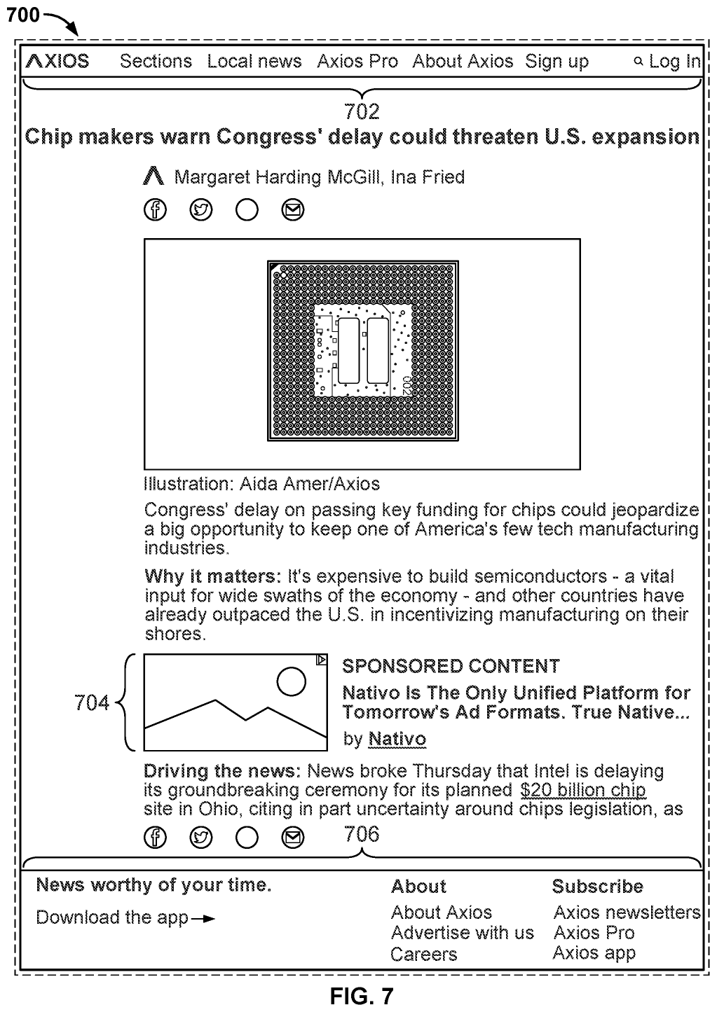

FIG. 7 is a diagram illustrating an example of a modified instance of a publisher content page in accordance with some embodiments. In the example shown, publisher content page 700 includes a header 702, a display area 704 that includes a native advertisement, and a footer area 706. In some embodiments, the footer area 706 is optional. The code associated with publisher content page 700 includes metadata to render content associated with the native advertisement, metadata of the content associated with the native advertisement, and the content associated with the native advertisement.

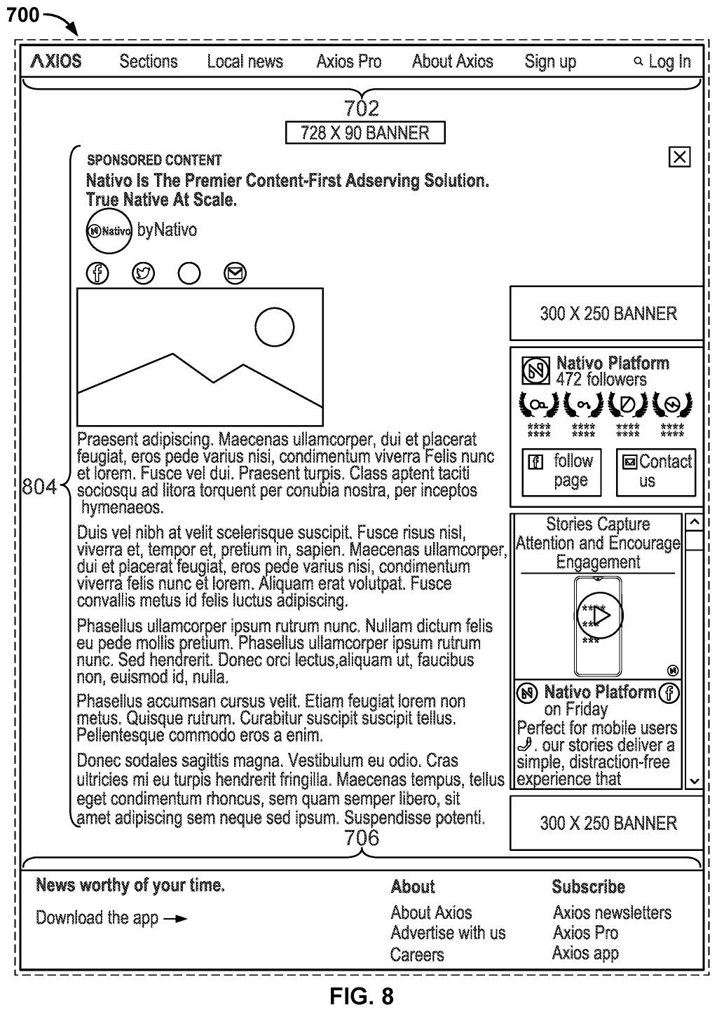

A browser or application displaying publisher content page 700 may receive a selection of the native advertisement 704. The browser or application is running a script (e.g., JavaScript). In response to the selection of the native advertisement 704, the script utilizes the metadata to render content associated with the native advertisement as an overlay below header 702. As seen in FIG. 8, the content of the native advertisement 804 is displayed as an overlay in the content area below header 702 and above footer 706. In some embodiments, the footer 706 is optional and the content of the native advertisement 804 is displayed as an overlay over the entire area below header 702.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a communication interface configured to receive a request for a native advertisement to be included in an instance of a publisher content page; and
a processor coupled to the communication interface and configured to send to a requesting client via the communication interface in response to the request code comprising the native advertisement which, when executed by the requesting client, is configured to:
modify the instance of the publisher content page to include an element to display a native advertisement content as an overlay covering at least a portion of the modified instance of the publisher content page responsive to a user input associated with the element included in the modified instance of the publisher content page, and
display the modified instance of the publisher content page.

2. The system of claim 1, wherein the processor is configured to determine a header associated with the publisher content page.

3. The system of claim 2, wherein the processor is configured to determine the header associated with the publisher content page using a template specific to a publisher of the publisher content page.

4. The system of claim 3, wherein the template specific to the publisher of the publisher content page includes a cascading style sheet (CSS) selector.

5. The system of claim 2, wherein the processor is further configured to determine which version of the native advertisement content to include in the code based on the header of the publisher content page.

6. The system of claim 5, wherein the determined version of the native advertisement content is an overlay covering an area below the header of the modified instance of the publisher content page.

7. The system of claim 5, wherein the determined version of the native advertisement content is an overlay covering an entire area of the modified instance of the publisher content page.

8. The system of claim 7, wherein the overlay covering the entire area of the modified instance of the publisher content page includes a logo or other identifying information associated with a publisher of the publisher content page.

9. The system of claim 1, wherein the native advertisement content includes an image, an article, a video, or other promotional content.

10. The system of claim 1, wherein the native advertisement content is hidden from being rendered until the requesting client displaying the modified instance of the publisher content page receives the user input associated with the element.

11. The system of claim 1, wherein the code is a script.

12. The system of claim 1, wherein the code includes at least at least metadata to render the native advertisement content and the native advertisement content.

13. The system of claim 1, wherein the modified instance of the publisher content page includes a header, content of the publisher content page, and at least the native advertisement.

14. The system of claim 1, wherein the native advertisement is associated with a winning bid is of an auction.

15. The system of claim 1, wherein in response to a selection of the native advertisement, the requesting client is configured to display the native advertising content as the overlay covering at least the portion of the modified instance of the publisher content page.

16. The system of claim 15, wherein the requesting client is configured to monitor user behavior while the content associated with the selected native advertisement is displayed.

17. A method, comprising:
receiving a request for a native advertisement to be included in an instance of a publisher content page; and
sending to a requesting client via a communication interface in response to the request code comprising the native advertisement which, when executed by the requesting client, causes the requesting client to:
modify the instance of the publisher content page to include an element to display a native advertisement content as an overlay covering at least a portion of the modified instance of the publisher content page responsive to a user input associated with the element included in the modified instance of the publisher content page, and
display the modified instance of the publisher content page.

18. The method of claim 17, further comprising determining a header associated with the publisher content page.

19. The method of claim 18, further comprising determining which version of the native advertisement content to include in the code based on the header of the publisher content page.

20. A computer program product embodied in a non-transitory computer readable medium and comprising computer instructions for:
receiving a request for a native advertisement to be included in an instance of a publisher content page; and
sending to a requesting client via a communication interface in response to the request code comprising the native advertisement which, when executed by the requesting client, causes the requesting client to:
modify the instance of the publisher content page to include an element to display a native advertisement content as an overlay covering at least a portion of the modified instance of the publisher content page responsive to a user input associated with the element included in the modified instance of the publisher content page, and
display the modified instance of the publisher content page.
